(19) United States
(12) Patent Application Publication
(10) Pub. No.: US 2021/0158246 A1
(43) Pub. Date: May 27, 2021

(54) OPTIMIZING FRAGMENTED WORK TEAMS WITH VISUALIZATION AND DEFRAGMENTATION

(71) Applicant: International Business Machines Corporation, Armonk, NY (US)

(72) Inventors: Nathan Andrew Pratt, Moberly, MO (US); Michael H. Roehl, New Fairfield, CT (US)

(21) Appl. No.: 16/693,338

(22) Filed: Nov. 24, 2019

(51) Int. Cl. G06Q 10/06; G06F 7/08; G06F 16/245

(52) U.S. Cl. CPC G06Q 10/06312; G06F 16/245; G06F 7/08

(57) ABSTRACT

An approach for optimizing employee workload is disclosed. The approach includes retrieving utilization data associated with employee workload and determining a highest utilized employee based on the retrieved data. The approach determines a lowest utilized employee based on the retrieved data and calculates a delta target utilization of the lowest utilized employee. The approach determines whether the delta target is greater than a first workload associated with the lowest utilized employee and the approach determines if the sum of the first workload and a second workload associated with the highest utilized employee is less than a target utilization then the approach can reassign the first workload to the highest utilized employee.

### BACKGROUND

The present invention relates generally to the field of resource management, and more particularly to managing resource supply and demand associated with the deployment of a work force or other resources.

Employee utilization is one of many criteria used by managers in a company to determine workload efficiency. Full-time equivalent (FTE) is a unit that indicates the workload of an employee in a way that makes workloads comparable across various contexts/projects/accounts. Managers assign new workload and tasks to various employees based on the employee's current workload. The goal is to optimize each employee's productivity to maximize profit for the company. Additionally, managers may transfer work from one employee to another employee to find the balance between increasing profit and reducing employee burn-out.

### SUMMARY

Aspects of the present invention disclose a computer-implemented method, computer program product, and computer system for optimizing employee workload. The computer implemented method includes retrieving utilization data associated with employee workload; determining a highest utilized employee based on the retrieved data; determine a lowest utilized employee based on the retrieved data; calculating a delta target utilization of the lowest utilized employee based on the retrieved data; determining whether the delta target is greater than a first workload associated with the lowest utilized employee; responsive to the delta target being greater than the first workload, determining if the sum of the first workload and a second workload associated with the highest utilized employee is less than a target utilization; and responsive to the sum being less than the target utilization, reassigning the first workload to the highest utilized employee.

In another embodiment, the computer program product includes one or more computer readable storage media and program instructions stored on the one or more computer readable storage media, the program instructions comprising: instructions to determine a highest utilized employee based on the retrieved data; program instructions to determine a lowest utilized employee based on the retrieved data; program instructions to calculate a delta target utilization of the lowest utilized employee based on the retrieved data; program instructions to determine whether the delta target is greater than a first workload associated with the lowest utilized employee; responsive to the delta target being greater than the first workload, program instructions to determine if the sum of the first workload and a second workload associated with the highest utilized employee is less than a target utilization; and responsive to the sum being less than the target utilization, program instructions to reassign the first workload to the highest utilized employee.

In another embodiment, the computer system includes one or more computer processors; one or more computer readable storage media; program instructions stored on the one or more computer readable storage media for execution by at least one of the one or more computer processors, the program instructions comprising: program instructions to retrieve utilization data associated with employee workload; program instructions to determine a highest utilized employee based on the retrieved data; program instructions to determine a lowest utilized employee based on the retrieved data; program instructions to calculate a delta target utilization of the lowest utilized employee based on the retrieved data; program instructions to determine whether the delta target is greater than a first workload associated with the lowest utilized employee; responsive to the delta target being greater than the first workload, program instructions to determine if the sum of the first workload and a second workload associated with the highest utilized employee is less than a target utilization; and responsive to the sum being less than the target utilization, program instructions to reassign the first workload to the highest utilized employee.

### BRIEF DESCRIPTION OF THE DRAWINGS

FIG. 1 is a functional block diagram illustrating a topology of an employee utilization environment, designated as 100, in accordance with an embodiment of the present invention;

FIG. 2 is a functional block diagram illustrating employee utilization component in accordance with an embodiment of the present invention;

FIG. 3A is a flowchart illustrating the operation of employee utilization component 111, designated as 300A, in accordance with an embodiment of the present invention; and

FIG. 3B is a flowchart illustrating an alternative operation of employee utilization environment 100, designated as 300B, in accordance with another embodiment of the present invention; and

FIG. 4 depicts a block diagram, designated as 400, of components of a server computer capable of executing the utilization component 111 within the employee utilization environment, of FIG. 1, in accordance with an embodiment of the present invention.

### DETAILED DESCRIPTION

Embodiments of the present invention provides an efficient approach to optimizing employee utilization assigned to various projects and/or tasks. The approach has a clear, repeatable, and analytical methodology for quick identification of low utilization and fragmentation. Advantages of the approach can provide estimate optimal utilization, calculate gaps to optimal, and propose staffing changes.

Furthermore, the approach can provide the user the ability to select a specific area and skillset to defragment and optimize. For example, assume employee1 has an over utilization of 75% composed of 55% to Account A and 20% to Account B; employee2 has an overall utilization of 45% composed of 20% to Account A and 25% to Account C. After analysis by the approach, the work from employee2 for Account A could be given to employee1, increasing employee1's overall utilization to 95% and leaving employee2 with 25% utilization to resolution when looking at Account C. Similarly, the approach can be applied to work that is fragment in other ways such as tasks. The defragmenting step of approach relies upon a calculation (based on Loose-fit algorithm) to determine the overall utilization within this account and skill set prior to and after the changes. Furthermore, an additional calculation (based on Tight-fit algorithm) can show the minimum number of employees needed on this account to perform all the work currently being performed. For example, using the previous example, employee2 has only 25% overall utilization and is dedicated to Account C. Assume the facts for employee1 stays the same (employee1 has an over utilization of 75% composed of 55% to Account A and 20% to Account B), employee3 has an 80% total utilization rate (50% for Account C) and employee4 with 70% total utilization (65% for Account C). Assume that after solutioning for Account A, the next iteration is to find a solution for Account C with employees with the same skillset. Thus, the approach would analyze and determine that by taking Account C from employee2 and giving it to employee4 would totally free up employee2 and that employee can be assigned to other tasks/projects/accounts. Thus, employee1, employee2 and employee3 that work on Account A, the average utilization rate for that account increase from 60% to 95%. And those employees that work on Account C, the average utilization rate increase from 65% to 87.5%.

A detailed description of embodiments of the claimed structures and methods are disclosed herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

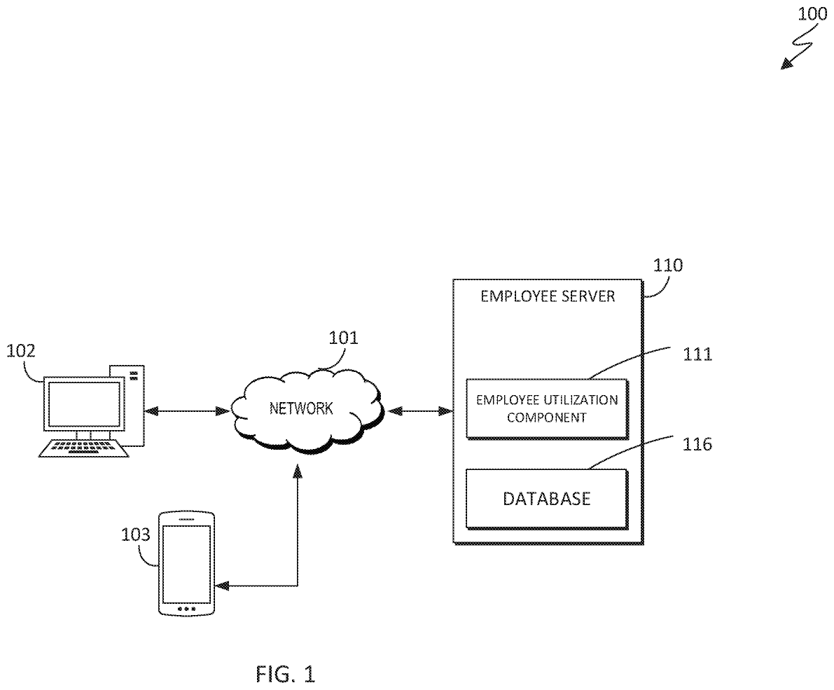

FIG. 1 is a functional block diagram illustrating a topology of an employee utilization environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Employee utilization environment 100 includes client computing device 102, mobile computing device 103 and employee server 110. All (e.g., 102 and 110) elements can be interconnected over network 101.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between employee server 110 and other computing devices (not shown) within employee utilization environment 100. It is noted that other computing devices can include, but is not limited to, client computing device 102 and any electromechanical devices capable of carrying out a series of computing instructions.

Client computing device 102 represents a network capable mobile computing device that may receive and transmit confidential data over a wireless network. Mobile computing device 102 can be a laptop computer, tablet computer, netbook computer, personal computer (PC), a personal digital assistant (PDA), a smart phone, smart watch (with GPS location) or any programmable electronic device capable of communicating with server computers (e.g., employee server 110) via network 101, in accordance with an embodiment of the present invention.

Mobile computing device 103 represents a network capable mobile computing device that may receive and transmit confidential data over a wireless network. Mobile computing device 103 can be a laptop computer, tablet computer, netbook computer, personal computer (PC), a personal digital assistant (PDA), a smart phone, smart watch (with GPS location) or any programmable electronic device capable of communicating with server computers (e.g., employee server 110) via network 101, in accordance with an embodiment of the present invention.

Employee server 110 can be a standalone computing device, a management server, a web server, a mobile computing device, or any other electronic device or computing system capable of receiving, sending, and processing data. In other embodiments, employee server 110 can represent a server computing system utilizing multiple computers as a server system, such as in a cloud computing environment. In another embodiment, employee server 110 can be a laptop computer, a tablet computer, a netbook computer, a personal computer (PC), a desktop computer, a personal digital assistant (PDA), a smart phone, or any other programmable electronic device capable of communicating other computing devices (not shown) within 100 via network 101. In another embodiment, employee server 110 represents a computing system utilizing clustered computers and components (e.g., database server computers, application server computers, etc.) that act as a single pool of seamless resources when accessed within employee utilization environment 100.

Employee server 110 includes employee utilization component 111 and database 116.

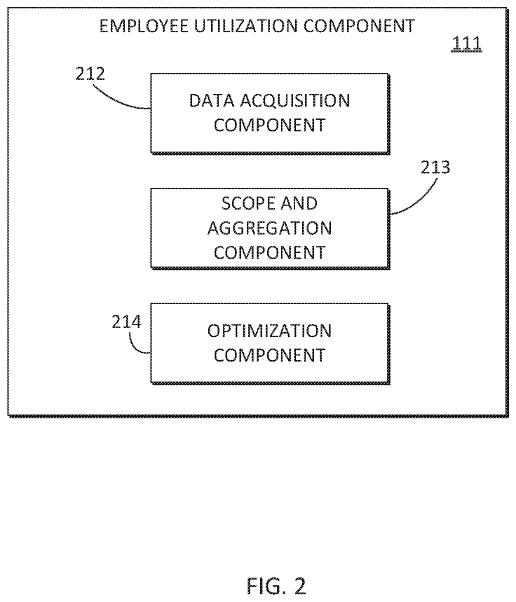

Employee utilization component 111 enables the present invention to analyze fragmented work teams and make recommendation specific level consolidation and re-deployment. Employee utilization component 111 will be described in greater details in regard to FIG. 2.

Database 116 is a repository for data used by employee utilization component 111. Database 116 can be implemented with any type of storage device capable of storing data and configuration files that can be accessed and utilized by employee server 110, such as a database server, a hard disk drive, or a flash memory. Database 116 uses one or more of a plurality of techniques known in the art to store a plurality of information. In the depicted embodiment, database 116 resides on employee server 110. In another embodiment, database 116 may reside elsewhere within employee utilization environment 100, provided that employee utilization component 111 has access to database 116. Database 116 may store information associated with, but is not limited to, corpus knowledge of skill sets of each employees, total utilization of each employee, tasks/projects/accounts assigned to each employee, client billing, target dates for all tasks/projects.

It is noted that there are some requirements for the data before any analysis can commence. Each record must represent a unit of hours for an individual, there should be some way to differentiate hours that contributes to utilization vs hours that do not (i.e., in this scenario, there are total hours, productive hours, billable hours, and chargeable hours). Where chargeable is a subset of billable, billable is a subset of productive, and productive is a subset of total). Each record should have an identifier tied to a person/employee and each person should have some classifier pertaining to skillset. Each record should have some level of granularity (not required, but the problem is simple to solve if there is no sectioning of the solution) to section the work for solutioning.

FIG. 2 is a functional block diagram illustrating employee utilization component 111 in accordance with an embodiment of the present invention. In the depicted embodiment, employee utilization component 111 includes data acquisition component 212, scope and aggregation component 213 and optimization component 214.

The following use case will be used to illustrate employee utilization component 111 including all subcomponents. The law firm has four clients (Client1, Client2, Client3 and Client4) and has three attorneys assigned to those four clients, (Employee1, Employee2 and Employee3). However, there is another attorney, Employee4, not assigned to any client. A managing partner at the law firm is trying to determine resource management for each client based on available employees. The assumption is that all four employees have the necessary skillset to be assigned to work for Client1, Client2 and Client3. Another assumption is that the threshold for total utilization for each employee should not exceed 95% (i.e., 96% or above). All the previous mentioned values (e.g., employee utilization, accounts, utilization threshold, etc.) resides in a CSV (comma separated value) file.

As is further described herein below, data acquisition component 212, of the present invention provides the capability of retrieving dataset (e.g., flat files, database, etc.) over the network (i.e., 101) or a local copy to be analyzed. Referring to our use case, data acquisition component 212 retrieves employee data of Law firm XYZ from the local hard drive. The data contains each employee workload regarding each client (see Table 1).

TABLE 1

| | Client1 | Client2 | Client3 | Total Utilization |
|---|---|---|---|---|
| Employee1 | 20% | 40% | 20% | 80% |
| Employee2 | | 10% | 25% | 35% |
| Employee3 | 20% | | 50% | 70% |
| Employee4 | | | | 0% |

As is further described herein below, scope and aggregation component 213 of the present invention provides, in real time, the capability of applying a calculation, using either a tight-fit algorithm, loose-fit algorithm or both algorithms, to determine the overall utilization within an account (i.e., client) and skillset prior to and after the change. Tight fit algorithm can be defined as aggregating all utilization to an account/sector based on the skillset and divide that number by the target utilization to calculate a total FTE (Full-Time equivalent) consumed for work (associated with that scope). Thus, tight-fit algorithm would be mainly used to give statistics of the data. For example, applying a tight-fit algorithm to Table 1, the result information can be summarized as “There are two employees dedicated to Client3, but in order to be more efficient, it is possible to only use one employee for Client3.” Conversely, loose-fit algorithm allows for rearrangement (i.e., stacking) of work by the employee without making an assumption that work can be infinitely segmented. For example, using the prior mentioned use case, scope and aggregation component 213 would apply the loose-fit algorithm on the data in table 1. The result of applying the loose-fit algorithm (first iteration) is illustrated by table 2.

TABLE 2

| | Client1 | Client2 | Client3 | Total Utilization |
|---|---|---|---|---|
| Employee1 | 20% | 40% | 20% | 80% |
| Employee2 | | | 25% | 25% |
| Employee3 | 20% | 10% | 50% | 80% |
| Employee4 | | | | 0% |

After applying the loose-fit algorithm, Employee2's workload on Client 2 was given to Employee3 which frees up Employee2 to be dedicated to Client 3.

In another embodiment, it is possible for optimization component 214 to assign Employee2's only workload (i.e., Client2) to Employee1 since it does not exceed the 95% total utilization threshold for all employees (i.e., Employee1's original total utilization of 80% would increase to 90% under the 95% threshold).

As is further described herein below, optimization component 214, of the present invention provides the capability of determining the minimum number of employees needed on a particular account to perform all the work currently being performed. Optimization component 214 can either use a tight-fit algorithm, loose-fit algorithm or a combination of both algorithm to make that determination. For example, using Table 2 to illustrate, optimization component 214 can be applied to data in Table 2 which would result in Table 3.

TABLE 3

| | Client1 | Client2 | Client3 | Total Utilization |
|---|---|---|---|---|
| Employee1 | 20% | 40% | 20% | 80% |
| Employee2 | | | | 0% |
| Employee3 | 20% | 10% | 50% | 80% |
| Employee4 | | | 25% | 25% |

After applying the loose-fit algorithm (second iteration), Employee2's only remaining workload, Client 3, can be given to Employee4 which frees up Employee2.

In yet another embodiment, assuming that scope and aggregation component 213 assigns Employee2's Client2 to Employee1 instead (see Table 4). Employee1's total utilization increase from 80% to 90% (still under the 95% threshold).

TABLE 4

| | Client1 | Client2 | Client3 | Total Utilization |
|---|---|---|---|---|
| Employee1 | 20% | 50% | 20% | 80% |
| Employee2 | | | | 0% |
| Employee3 | 20% | | 75% | 95% |
| Employee4 | | | | 0% |

Furthermore, optimization component 214 can assign Employee2's remaining workload (i.e., Client3) to Employee3 (see Table 4). Thus, employee3's original total utilization of 70% would increase to 95%). Therefore, Employee2 is freed up to pursue another workload, along with Employee4.

In general, the subcomponents (213 and 214) of employee utilization component 111 can be summarized by the following equation:

Δtarget=targetUtilization−totalUtilization Employee

TargetUtilization is a user predefined number that is setup as a threshold which each employee's total utilization should not exceed. TotalUtilization is the total utilization for each employee based on percentage dedicated to each tasks/projects/account. For example, targetUtilization is 96%, EmployeeA's total utilization is 95%, EmployeeB's total utilization is 50% and EmployeeZ's total utilization is 5%. Employee utilization component 111 would find the highest utilized employee (i.e., EmployeeA), that employee would be compared against the lowest utilized employee (i.e., EmployeeZ). Hence, Δtarget would become 96-95=1. Then Δtarget is compared to the in-scope utilization of the lowest (i.e., is 1>5?). No, EmployeeA does not have capacity to take EmployeeZ's work for the client then 111 would consider EmployeeB next. Hence, Δtarget for EmployeeB is 96-50=46. This value (46) is then used in the expression, Δtarget>totalUtilization EmployeeZ (i.e., is 46>5 ?). If the answer is “Yes” then work from EmployeeZ is then transferred to the higher utilized employee, EmployeeB. The work cannot be given to EmployeeA since that would bring that employee's total utilization above the threshold of 96% (i.e., EmployeeA's utilization would increase from 95% to 100% if EmployeeA were given EmployeeZ's workload). However, if the answer is “No,” the work remains in place and employee utilization component 111 finds the next highest utilized employee.

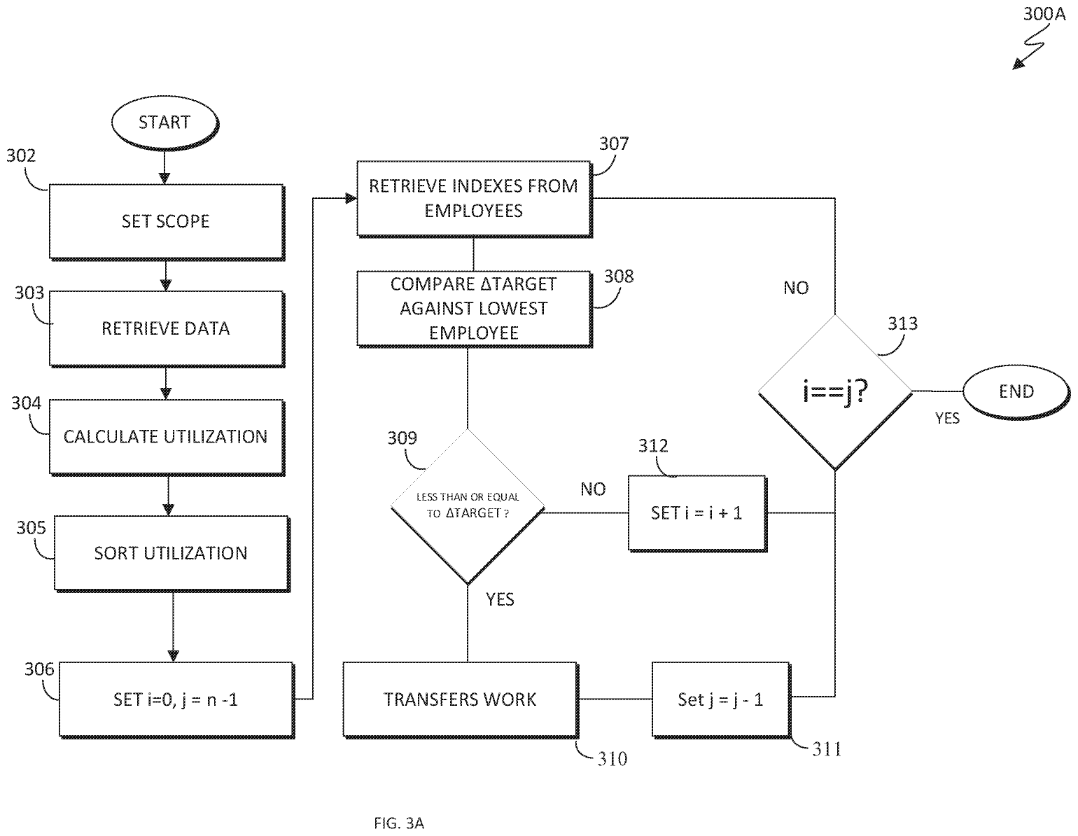

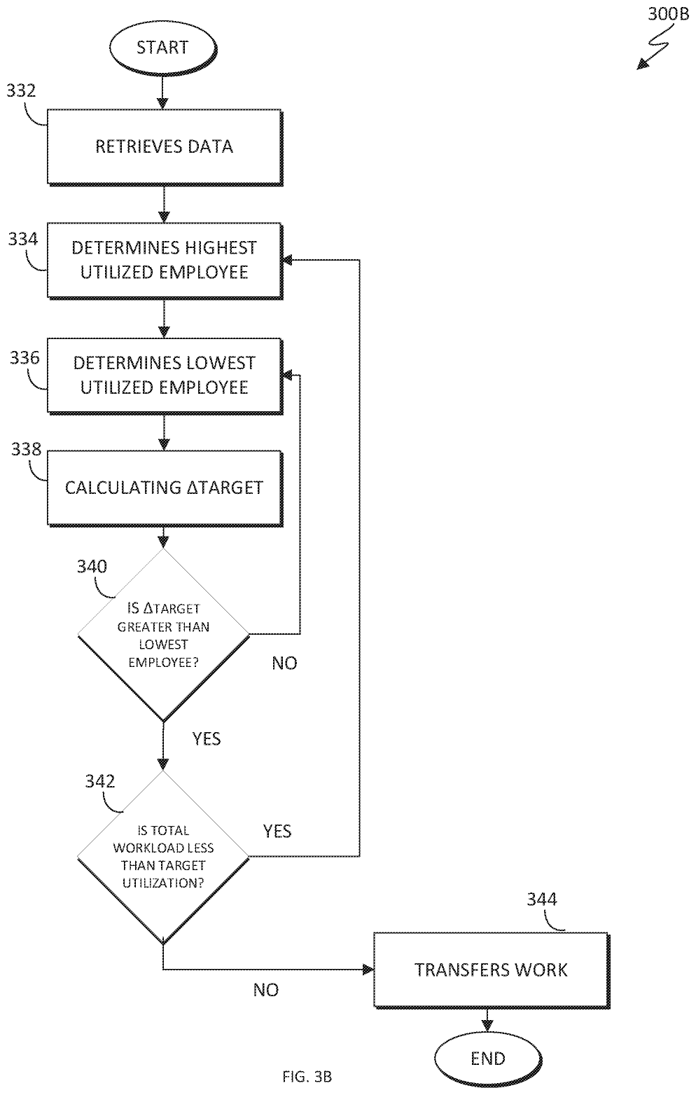

FIG. 3A is a flowchart illustrating the operation of an employee utilization environment 100, designated as 300A, in accordance with an embodiment of the present invention.

Employee utilization component 111 sets the scope (step 302). The user can specify the scope of the operation to be performed such as “Account,” “Market” or “Skillset.”

Employee utilization component 111 retrieves data (step 303). In an embodiment, employee utilization component 111, through data acquisition component 212, retrieves employee related data set to begin analysis. For example, data acquisition component 212 loads a CSV file from a local copy on user's PC (e.g., 102 or 103) such as Table 1.

Employee utilization component 111 calculates utilization (step 304). In an embodiment, employee utilization component 111, calculates the total utilization of each employee that's assigned to a task/project/accounts. It is noted that some data for employee's total utilization may already have been calculated and stored in the data set. For example, Table 1 already contains each employee's total utilization calculation. It is noted that in cases where utilization percentage (for each employee) needs to be calculated, such as, billable hours for each week (i.e., the values would need to be aggregated to calculate utilization).

Employee utilization component 111 sort utilization (step 305). In an embodiment, employee utilization component 111 sorts the data based on in-scope utilization (i.e., high to low). For example, referring to Table 1, the highest utilized employee Employee1 and followed by Employee3 and Employee2.

Employee utilization component 111 can represent the highest utilized employee as an index, i, and can represent the least utilized employee as an index, j, and n can represent the total number of employees in the data (step 306). Hence, i=0 and j=n−1.

Employee utilization component 111 retrieves indexes from employees (step 307). In an embodiment, employee utilization component 111, iterates inward from the highest and lowest utilized employee for the scope (i.e., Employee1 is assigned an index of i and Employee2 is assigned an index of j). For example, per Table 1 for scope Client2, the highest utilized employee is Employee1 and the lowest utilized employee is Employee2 (with Employee3 and Employee4 contributing 0% to Client2.

Employee utilization component 111 compares the lowest utilized employee (in-scope utilization) against a Δtarget (step 308). In an embodiment, recall that i represents the next highest total utilization and j represents the next lowest in-scope utilization, employee utilization component 111 compares the lowest utilization employee against the Δtarget (i.e., 15%=95%-80%). For example, per Table 1, Employee2's in-scope utilization (i.e., 10%) is compared against Δtarget (i.e., is 10%<=15%?).

In an embodiment, employee utilization component 111 determines whether the lowest utilized employee is less than the Δtarget (decision block 309). If Δtarget is greater than employee's in-scope utilization (“YES” branch, decision block 309) then employee utilization component 111 proceeds to step 310. For example, per Table 1, Δtarget is 15% and the lowest utilized employee is 10% in-scope. Thus, employee utilization component 111 would proceed to step 310. If Δtarget is not greater than employee's in-scope utilization (“NO” branch, decision block 309) then employee utilization component 111 proceeds to step 312.

Employee utilization component 111 transfers work (step 310). In an embodiment, employee utilization component 111, transfers work from the lowest utilized employee (in-scope) to the next highest utilized employee where the next highest utilized employee's total utilization does not exceed the threshold. For example, per Table 1, Employee2's client2 (10% of 35% of Employee's total utilization) work is assigned Employee1. Why didn't employee utilization component 111 transfer client3 (35%) of Employee2 instead? This iteration is solutioning for Client2 and a future iteration will solve for the chunk of work from Client3 if possible.

Employee utilization component 111 set j=j−1 (step 311). In an embodiment, upon giving up in scope work, employee utilization component 111 will decrement the lowest employee index to get the next lowest utilization (in-scope) and repeat from step 307, where i !=j (i.e., the highest utilized is not the lowest utilized; i does not equal j).

Employee utilization component 111 set i=i+1 (step 312). In an embodiment, employee utilization component 111 sets the increment index i to the next highest utilized employee.

Employee utilization component 111 determines whether there are any more employees left to compare (decision block 313). In an embodiment, employee utilization component 111 determines whether there are any more employees (from the data set) left to compare (i.e., is i equal to j?). If there are employees left from the data set to compare (“NO” branch, decision block 313) then employee utilization component 111 searches for the next highest utilized employee from the data set (step 307). This was determined by incrementing i or decrementing j based on the outcomes of decision block 309. If there are no employees left from the data set (“YES” branch, decision block 313) then employee utilization component 111 ends the optimization process for this iteration. And the entire process can be ready for the next iteration using a new scope (i.e., Client3).

FIG. 3B is a flowchart illustrating an alternative operation of employee utilization environment 100, designated as 300B, in accordance with another embodiment of the present invention.

Employee utilization component 111 retrieves data (step 332). In an embodiment, employee utilization component 111, through data acquisition component 212, retrieves employee related data set to begin analysis. For example, data acquisition component 212 loads a CSV file from a local copy on user's PC (e.g., 102 or 103) such as Table 1.

Employee utilization component 111 determines the highest utilized employee (step 334). In an embodiment, employee utilization component 111 sorts the data based on in-scope utilization (i.e., high to low) and determines the highest utilized employee. For example, referring to Table 1, the highest utilized employee is Employee1 and followed by Employee3 and Employee2. It is noted that some data for employee's total utilization may already have been calculated and stored in the data set. For example, Table 1 already contains each employee's total utilization calculation. It is noted that in cases where utilization would need to be calculated includes those where the data contains claim from each week (i.e., the values would need to be aggregated to calculate utilization).

Employee utilization component 111 determines the lowest utilized employee (step 336). In an embodiment, employee utilization component 111 sorts the data based on in-scope utilization (i.e., low to high) and determines the lowest utilized employee. For example, referring to Table 1, the lowest utilized employee is Employee2.

Employee utilization component 111 compares the lowest utilized employee (in-scope utilization) against a Δtarget (step 338). In an embodiment employee utilization component 111 compares the lowest utilization employee against the Δtarget. For example, per Table 1, Employee2's in-scope utilization (i.e., 10%) is compared against Δtarget (i.e., is 10%<=15%?).

In an embodiment, employee utilization component 111 determines whether the lowest utilized employee is less than the Δtarget (decision block 340). If Δtarget is greater than employee's in-scope utilization (“YES” branch, decision block 340) then employee utilization component 111 proceeds to step 342. For example, per Table 1, Δtarget is 15% and the lowest utilized employee is 10% in-scope. Thus, employee utilization component 111 would proceed to step 342. If Δtarget is not greater than employee's in-scope utilization (“NO” branch, decision block 340) then employee utilization component 111 proceeds return to step 336.

Employee utilization component 111 determines whether the total workload is less than the target utilization (decision block 342). In an embodiment, employee utilization component 111 determines whether adding the workload from the lowest utilized employee (identified in step 336) to the highest utilized employee (identified in step 334) would exceed the target utilization. For example, per Table 1, work for client3 (25% of Employee2's total workload) for Employee2 would be given to Employee1. Employee utilization component determines whether by adding 25% to Employee1's total utilization (80%) would exceed the target utilization for all employee (i.e., currently set at 95%). If adding the workload to Employee1 exceeds the target utilization (“YES” branch, decision block 342) then employee utilization component 111 returns to step 334 (i.e., finding the next highest utilized employee). However, if adding 25% to Employee1 doesn't exceed (“NO” branch, decision block 342) then employee utilization component 111 proceeds to transfer the work (step 344).

Alternatively, it can be seen from Table 1 that Employee2 has two clients, Client2 and Client3 which accounts for 10% and 25% of Employee2's time, respectively. Thus, employee utilization component can select client1 (10% of Employee2's workload) to add to Employee1 instead of using client2 (25% of Employee2's workload). And the decision process can be ready for the next iteration using a new scope (i.e., next client of employee).

Employee utilization component 111 transfers work (step 344). In an embodiment, employee utilization component 111, transfers work from the lowest utilized employee (in-scope) to the next highest utilized employee where the next highest utilized employee's total utilization does not exceed the threshold. For example, per Table 1, Employee2's client2 (10% of 35% of Employee's total utilization) work is assigned Employee1. Why didn't employee utilization component 111 transfer client3 (35%) of Employee2 instead? This iteration is solutioning for Client2 and a future iteration will solve for the chunk of work from Client3 if needed.

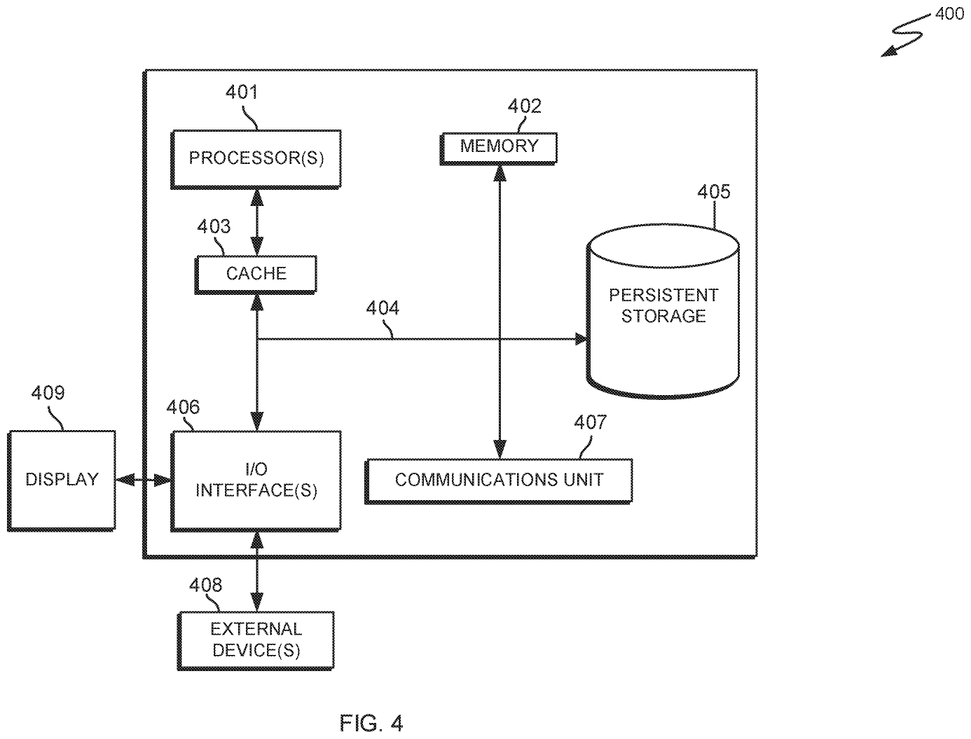

FIG. 4 depicts a block diagram, designated as 400, of components of employee utilization component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data ×10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Employee utilization component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communication links. Program instructions and data (e.g., Employee utilization component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Employee utilization component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed:

1. A computer-implemented method for optimizing employee workload, the computer-implemented method comprising:
retrieving utilization data associated with employee workload;
determining a highest utilized employee based on the retrieved data;
determine a lowest utilized employee based on the retrieved data;
calculating a delta target utilization of the lowest utilized employee based on the retrieved data;
determining whether the delta target is greater than a first workload associated with the lowest utilized employee;
responsive to the delta target being greater than the first workload, determining if the sum of the first workload and a second workload associated with the highest utilized employee is less than a target utilization; and
responsive to the sum being less than the target utilization, reassigning the first workload to the highest utilized employee.

2. The computer-implemented method of claim 1, wherein determining the highest utilized employee, further comprises:
sorting the utilization data based on a highest utilization number, wherein sorting place the highest utilized number as a first record;
determining whether the first record is less than the target utilization; and
responsive to determining that the first record is less than the target utilization choosing the first record as the highest utilized employee.

3. The computer-implemented method of claim 1, wherein determine the lowest utilized employee, further comprises:
sorting the utilization data based on a lowest utilization number, wherein sorting places the lowest utilized number as a last record; and
choosing the last record as the lowest utilized employee.

4. The computer-implemented method of claim 1, wherein calculating a delta target utilization of the lowest utilized employee, further comprises:
subtracting a utilization number associated with the lowest utilized employee from the target utilization.

5. The computer-implemented method of claim 1, wherein target utilization number is user adjustable.

6. The computer-implemented method of claim 1, wherein determining if the sum of the first workload and a second workload is less than the target utilization, further comprises:
adding the first workload and the second workload into a combined workload, comparing the combined workload against the target utilization.

7. The computer-implemented method of claim 1, wherein reassigning the first workload to the highest utilized employee, further comprises:
adding a third utilization percentage associated with first workload to a fourth utilization number associated with highest utilized employee;
determining whether the added utilization percentage is greater than the target utilization; and
responsive in determining that the added utilization is not greater than the target utilization, transferring the first workload to the highest utilized employee.

8. A computer program product for optimizing employee workload, the computer program product comprising:
one or more computer readable storage media and program instructions stored on the one or more computer readable storage media, the program instructions comprising:
program instructions to retrieve utilization data associated with employee workload;
program instructions to determine a highest utilized employee based on the retrieved data;
program instructions to determine a lowest utilized employee based on the retrieved data;
program instructions to calculate a delta target utilization of the lowest utilized employee based on the retrieved data;
program instructions to determine whether the delta target is greater than a first workload associated with the lowest utilized employee;
responsive to the delta target being greater than the first workload, program instructions to determine if the sum of the first workload and a second workload associated with the highest utilized employee is less than a target utilization; and
responsive to the sum being less than the target utilization, program instructions to reassign the first workload to the highest utilized employee.

9. The computer program product of claim 8, wherein determining the highest utilized employee, further comprises:
program instructions to sort the utilization data based on a highest utilization number, wherein sorting place the highest utilized number as a first record;
program instructions to determine whether the first record is less than the target utilization; and
responsive to determining that the first record is less than the target utilization, program instructions to choose the first record as the highest utilized employee.

10. The computer program product of claim 8, wherein determine the lowest utilized employee, further comprises:
program instructions to sort the utilization data based on a lowest utilization number, wherein sorting places the lowest utilized number as a last record; and
program instructions to choose the last record as the lowest utilized employee.

11. The computer program product of claim 8, wherein calculating a delta target utilization of the lowest utilized employee, further comprises:
program instructions to subtract a utilization number associated with the lowest utilized employee from the target utilization.

12. The computer program product of claim 8, wherein target utilization number is user adjustable.

13. The computer program product of claim 8, wherein determining if the sum of the first workload and a second workload is less than the target utilization, further comprises:
program instructions to add the first workload and the second workload into a combined workload, comparing the combined workload against the target utilization.

14. The computer program product of claim 8, wherein reassigning the first workload to the highest utilized employee, further comprises:
program instructions to add a third utilization percentage associated with first workload to a fourth utilization number associated with highest utilized employee;
program instructions to determine whether the added utilization percentage is greater than the target utilization; and
responsive in determining that the added utilization is not greater than the target utilization, program instructions to transfer the first workload to the highest utilized employee.

15. A computer system for optimizing employee workload, the computer system comprising:
one or more computer processors;
one or more computer readable storage media;
program instructions stored on the one or more computer readable storage media for execution by at least one of the one or more computer processors, the program instructions comprising:
program instructions to retrieve utilization data associated with employee workload;
program instructions to determine a highest utilized employee based on the retrieved data;
program instructions to determine a lowest utilized employee based on the retrieved data;
program instructions to calculate a delta target utilization of the lowest utilized employee based on the retrieved data;
program instructions to determine whether the delta target is greater than a first workload associated with the lowest utilized employee;
responsive to the delta target being greater than the first workload, program instructions to determine if the sum of the first workload and a second workload associated with the highest utilized employee is less than a target utilization; and
responsive to the sum being less than the target utilization, program instructions to reassign the first workload to the highest utilized employee.

16. The computer system of claim 15, wherein determining the highest utilized employee, further comprises:
program instructions to sort the utilization data based on a highest utilization number, wherein sorting place the highest utilized number as a first record;
program instructions to determine whether the first record is less than the target utilization; and
responsive to determining that the first record is less than the target utilization, program instructions to choose the first record as the highest utilized employee.

17. The computer system of claim 15, wherein determine the lowest utilized employee, further comprises:
program instructions to sort the utilization data based on a lowest utilization number, wherein sorting places the lowest utilized number as a last record; and
program instructions to choose the last record as the lowest utilized employee.

18. The computer system of claim 15, wherein calculating a delta target utilization of the lowest utilized employee, further comprises:
program instructions to subtract a utilization number associated with the lowest utilized employee from the target utilization.

19. The computer system of claim 15, wherein reassigning the first workload to the highest utilized employee, further comprises:
program instructions to add a third utilization percentage associated with first workload to a fourth utilization number associated with highest utilized employee; and
program instructions to determine whether the added utilization percentage is greater than the target utilization; and
responsive in determining that the added utilization is not greater than the target utilization, program instructions to transfer the first workload to the highest utilized employee.

20. The computer system of claim 15, wherein determining if the sum of the first workload and a second workload is less than the target utilization, further comprises:
program instructions to add the first workload and the second workload into a combined workload, comparing the combined workload against the target utilization.
